(19) United States
(12) Patent Application Publication
(10) Pub. No.: US 2026/0235443 A1
(43) Pub. Date: Aug. 13, 2026

(54) SPECTROMETER WITH ADJUSTABLE SENSITIVITY

(71) Applicant: AVANTES B.V., APELDOORN (NL)

(72) Inventors: Peter Edwin SPORTEL, APELDOORN (NL); Alexander Leonardus Lambertus BROEKHOF, APELDOORN (NL); Kenny Efraïm VAN NORDEN, APELDOORN (NL); Ronald ROERDINK, APELDOORN (NL); Tetyana Vitalivivna TOLPEKINA, APELDOORN (NL)

(73) Assignee: AVANTES B.V., APELDOORN (NL)

(21) Appl. No.: 19/150,793

(22) PCT Filed: Jan. 29, 2024
(86) PCT No.: PCT/NL2024/050037

§ 371 Date: Jul. 24, 2025

(30) Foreign Application Priority Data
Jan. 27, 2023 (NL) 2034032

(51) Int. Cl. G01J 3/28; G01J 3/02

(52) U.S. Cl. CPC G01J 3/28; G01J 3/0208; G01J 3/021; G01J 3/0229; G01J 3/0237; G01J 3/0291; G01J 3/0297

(57) ABSTRACT

Optical spectrometer for analysing an input optical signal, said input optical signal being inputted to the spectrometer, the optical spectrometer comprising: an optical aperture device, and an optical element. The optical aperture device is configured for receiving a first optical signal derived from the input optical signal and for selecting a portion of the first optical signal to generate a second optical signal exiting said optical aperture device. The optical element is configured for receiving on its surface the second optical signal exiting the optical aperture device. The optical aperture device is moveable with respect to the optical element to change the surface area of the second optical signal impinging on the optical element.

The present invention relates to spectrometers with moveable optical aperture devices for adjusting the spectral sensitivity.

Optical spectroscopy is a technique used to analyse optical signals which wavelengths may be in the ultraviolet (UV), visible (VIS), near-infrared (NIR) and/or infrared (IR) range of the electromagnetic spectrum. Spectroscopic measurements are used in many applications, such as color measurements, concentration determination of chemical components or electromagnetic radiation analyses.

Typically, a spectrometer is an optical measuring device comprising from input to output, along an optical path: an input slit, potentially an aperture, collimating optics, a dispersive element like a grating, lensing/focusing optics and finally a detector delivering the spectroscopic measurements. The input slit is typically used to control the amount of light entering the spectrometer and thus influences the (spectral) resolution and the throughput of the spectrometer. Typically, in such systems, the input slit is in a fixed position and the width of the input slit is selected based on the desired (spectral) resolution.

In an optical system, the throughput of the system is limited by the lowest throughput of any aperture of the system. In a spectrometer, this means the throughput is typically limited either by the input slit or by the pixel size of the detector. To have an optimized throughput in an optical system, the etendue of the light source, the collecting optics, and the etendue of the light receiving optics, optical fibres or monochromators, need to be closely matched. The etendue of a light source is equal to the source emitting area (S) times the solid angle (Ω) from which the light is collected for a specific application.

By spectral resolution or resolution, it is meant the maximum number of spectral peaks that the spectrometer can resolve. For example, if a spectrometer with a wavelength range of 200 nm had a spectral resolution of 1 nm, the system would be capable of resolving a maximum of 200 individual wavelengths (peaks) across a spectrum. There are typically three main factors that determine the spectral resolution of a spectrometer: the slit, the diffraction grating, and the detector. The slit determines the minimum image size that the optical bench of the spectrometer can form in the detector plane. The diffraction grating determines the total wavelength range of the spectrometer. The detector determines the maximum number and size of discreet points in which the spectrum can be digitized.

Another important parameter, when designing a spectrometer, is the (light) sensitivity or photometric sensitivity relating to how much light is needed for a detectable signal. The (light) sensitivity may be measured in photon counts, for example normalized per microwatt per millisecond of integration time (counts/μW per ms). The spectral sensitivity may be defined in turn by the light sensitivity response over the wavelength range.

In the prior art, replaceable slits are known and typically used to change the resolution. In practice, such replaceable slit elements of different slit sizes (widths) have to be physically exchanged to be able to change to the resolution of a given spectrometer. When altering the slit width in order to change the resolution, the ultimate availability of light detectable by the detector and therefore the throughput and as a result the spectral sensitivity of the system are also changed. Adjusting solely the throughput or the spectral sensitivity was thus not addressed in the prior art.

To alter specifically the sensitivity, the use of filters is further known from the prior art. Yet, a filter affects the sensitivity differently over the whole spectrum, such that solutions using filters did not enable an homogeneous adjustment of the spectral sensitivity, i.e. an homogenous adjustment of the sensitivity response over the whole wavelength range.

An object of the invention, next to other objects, is to provide improved spectrometers in which the spectral sensitivity may be easily adjusted. In particular, an object of the invention is to provide spectrometers in which the sensitivity response may be tuned independently from the resolution and homogenously over the wavelength range of said spectrometers.

This object, next to other objects, is met by an optical spectrometer according to claim 1.

Specifically, this is met by an optical spectrometer for analysing an input optical signal, said input optical signal being inputted to the spectrometer. The spectrometer comprises an optical aperture device configured for receiving a first optical signal derived from said input optical signal and for selecting a portion of the first optical signal to generate a second optical signal exiting said optical aperture device, and an optical element configured for receiving on its surface the light exiting the optical aperture device. The optical aperture device is moveable with respect to the optical element along a propagation direction of the first optical signal to change a surface area of the second optical signal impinging on the optical element. In this way, the size of the illuminated area on the optical element, and thus the sensitivity response of the spectrometer can be easily adjusted by moving it with respect to the optical device. It is noted that the optical spectrometer may be a reflective or a transmissive spectrometer. Yet, the invention may be applied to any sort of spectrometers suitable for it. Depending on embodiments, the optical element may comprise any one of: a collimating element, a reflecting element (for example, a plane mirror), a grating element (for example, a concave grating).

The spectrometer further comprises an optical entrance, configured for receiving the input optical signal and for generating and for generating the first optical signal, said first optical signal being a diverging beam, preferably a conical diverging beam. The (conical) diverging beam of the first optical signal may be defined by a solid angle, said solid angle being an half-angle of the cone formed by the (conical) diverging beam.

According to a preferred embodiment, the optical entrance may be configured for selecting a portion of the input optical signal to generate the first optical signal. More specifically, the generating of the first optical signal by the optical entrance may be achieved by optically attenuating the input optical signal. Generating the first optical signal as a diverging beam facilitates the cutting out, or selecting, of light from the first optical signal by the optical aperture device. Preferably the optical entrance may comprise a slit element, more preferably said slit element defining an input plane from which the first and the second optical signal originate and which distance to the optical element is predetermined. In this way, the input optical signal may be prepared for further processing by selecting a desired resolution. In particular in case of a slit element, the input optical signal may be processed to generate after the slit a first optical signal propagating from the input plane and configured to be received on the optical element to form an image. Alternatively, the optical entrance may be configured for coupling the input optical signal to the optical spectrometer to generate the first optical signal. More specifically the optical entrance may be an optical coupler for coupling an optical fibre used to input the input optical signal to the optical spectrometer.

Preferably, the optical entrance is arranged at a fixed predetermined distance d relative to the optical element. Further, the optical element may comprise a light receiving area thereof. The light receiving area may be defined by a height h and a width w. Based on the minimum between the width w and the height h of the light receiving area (i.e. a minimum lateral dimension of the light receiving area), and on the predetermined distance d, a maximum numerical aperture, NA, of the spectrometer may be derived.

According to a preferred embodiment, the optical aperture device may comprise an exit aperture element, said exit aperture element comprising a surface for blocking a portion of an incoming optical signal and an opening for letting another portion of the incoming optical signal through. In this way, a fine control of the amount of light exiting the optical aperture device can be performed while the distance between the exit aperture and the optical element and thus the size of the illuminated area on the optical element can be changed.

The optical aperture device may comprise a first extremity and a second extremity at the opposite thereof. As seen along the propagation direction of optical signals, the first extremity is located upstream of the second extremity. Preferably, the exit aperture element is provided closer to the second extremity than the first extremity of the optical aperture device, more preferably at the second extremity of the optical aperture device.

According to a preferred embodiment, the optical aperture device may further comprise an entrance aperture element, said entrance aperture element comprising a surface for blocking a portion of an incoming optical signal and an opening for letting another portion of the incoming optical signal through. In this way, stray light in the area before the optical aperture device (for example between an optical entrance like a slit and the optical aperture device) is prevented from travelling further down the optical path. Stray light may be defined as radiation of undesired wavelengths that if propagated may activate a response of the spectrometer. Sources of stray light may include ambient light, scattered light from imperfect optical components or reflections of non-optical components, as well as order overlap. Preferably, the entrance aperture element is provided closer to the first extremity than the second extremity of the optical aperture device, more preferably at the first extremity of the optical aperture device.

According to a preferred embodiment, the optical aperture device may comprise a tubular casing for holding the entrance aperture element and/or the exit aperture element. In this way, an easy displacement of the entrance and/or exit aperture element may be achieved by manipulating the tubular casing.

According to a preferred embodiment, the tubular casing may define a passage between the first extremity and the second extremity. The tubular casing may be provided to the spectrometer such that the first extremity is upstream of the second extremity as seen in a direction of propagation of the optical signals. The direction of propagation of the optical signals may also be referred to as the direction of the optical path. In this way the tubular casing may form a closed passage in which light, and especially stray light, may be trapped.

According to a preferred embodiment, the exit aperture element may be provided to the second extremity of the tubular casing. In this way, the tubular casing and the exit aperture element may form a closed passage with an output opening such that only a portion of the first optical signal can be let through while the rest is trapped inside the tubular casing. Potential stray light may then be prevented from travelling further downwards the direction of the propagation of the optical signals, i.e. further down the optical path (and especially towards the detector), improving thus the performance of the spectrometer. Alternatively, the exit aperture element may be provided to an intermediate portion of the tubular casing.

According to a preferred embodiment, the entrance aperture element may be provided to the first extremity of the tubular casing. In this way, the tubular casing and the aperture element may form a closed passage with an input opening such that only a portion of the first optical signal can be let through while the rest is blocked from entering the tubular casing and travelling further towards the detector. Potential stray light may then be prevented from travelling further downwards the direction of the propagation of the optical signals, i.e. further down the optical path (and especially towards the detector), improving thus the performance of the spectrometer. Alternatively, the entrance aperture element may be provided to an intermediate portion of the tubular casing upwards from the exit aperture element along the optical path. An entrance aperture element may be optional.

According to a preferred embodiment, the tubular casing may have an outer surface having a circular cross section. In this way, the tubular casing may be cylinder shaped on the outside, enabling an easy integration into the spectrometer. Yet other shapes of the outer surface may be envisaged.

According to a preferred embodiment, the tubular casing may have at least a portion of an inner surface configured for preventing light rays going through the exit aperture element after reflection on said inner surface section. In this way, in at least a portion of the inner surface, facets may be present. Such facets may be configured to avoid propagation of stray light, by deviating light rays impinging on the inner surface away from the main direction of propagation, i.e. away from the optical path and the optical axis of the optical aperture device. The optical axis of the optical aperture device may be the longitudinal axis of the tubular casing. In this way, stray light may be further reduced, improving thus further the performance of the spectrometer.

According to a preferred embodiment, the inner surface of the tubular casing may be any one of the following and combinations thereof: a cylindrical portion, a conical portion, a threaded portion, a spiral ribbed portion. In this way, stray light may be scattered against the reflective inner surface of the tubular casing in different directions, especially in directions which are not parallel with the optical axis of the optical aperture device, such that stray light may not be propagated along the optical path. In this way, stray light may be prevented from reaching the surface of the optical element, and in turn the surface of the following elements and ultimately the detector, thus reducing the influence of noise on the measurements.

According to a preferred embodiment, at least a portion of an inner surface of the tubular casing has a light absorbing coating. In this way, stray light may be further prevented from leaving the tubular casing and reaching the surface of the optical element. The coating may be applied to any type of inner surface as described previously, whether cylindrical, conical, threaded, spiral ribbed or others. Alternatively the tubular casing may be made of a material having light absorbing properties itself, such that no separate coating is necessary.

According to a preferred embodiment, the optical aperture device is moveable in a translation along an optical axis of the optical aperture device. In this way, a distance between the optical aperture device and the surface of the optical element can be adjusted by a simple translation. According to a preferred embodiment, the tubular casing may slide with respect to the optical element. Preferably, the tubular casing may slide without further any intermediate moving means. In this way, the tubular casing may be easily displaced with respect to the optical element. Alternatively, the tubular casing may be translated with respect to the optical element via moving means, like a linear motor, or any actuator suitable for that purpose.

According to a preferred embodiment, the optical aperture device is moveable between a first and a second position, wherein in the first position the surface area of the second optical signal impinging on the optical element is set to a predetermined maximum area while still being smaller than the total surface of the optical element, and wherein said illuminated area is reduced by moving the optical aperture device from the first position to a second position by at least 10%, preferably by at least 30%. The surface area of the second optical signal impinging on the optical element may be referred to as illuminated area. In this way, a calibration of the amount of light received on the optical element may be easily performed.

Preferably, the optical aperture device is configured such that, in the first position, i.e. the position of the optical aperture device furthest from the optical element, the second optical signal corresponds to 100% of the first optical signal. Furthermore, the optical element may be shaped such that, in the first position, the illuminated area substantially corresponds entirely to the light receiving area of the optical element. In other words, in the first position, the second optical signal may diverge in a manner defined by a same solid angle as the one defining the diverging beam of the first optical signal, said solid angle of the second optical signal corresponding to the maximum NA of the spectrometer.

Preferably, the optical aperture device is configured such that, in the second position, i.e. the position of the optical aperture device closest to the optical element, the second optical signal corresponds to between 40% and 60% of the first optical signal. In other words, in the second position, the second optical signal may diverge over a solid angle inferior to the solid angle defining the diverging beam of the first optical signal and inferior to the solid angle corresponding to the maximum NA of the spectrometer.

According to a preferred embodiment, the optical aperture device is moveable between a first position and a second position such that the sensitivity is adjusted by at least 10%, more preferably by at least 30%, even more preferably by at least 60%. In this way, a calibration of the sensitivity of the spectrometer, especially the spectral sensitivity, may be easily performed.

According to a preferred embodiment, the optical aperture device is moveable between a first position and a second position such that a resulting numerical aperture of an illuminated area of the second optical signal impinging on the optical element is adjustable from a maximum numerical aperture of the spectrometer. The maximum numerical aperture of the spectrometer is associated with the first position.

Preferably, in the above, the first position corresponds to a position of the optical aperture device furthest from the optical element. Additionally or alternatively the second position corresponds to a position of the optical aperture device closest to the optical element.

According to a preferred embodiment, the spectrometer may further comprise a housing for holding the optical element and the optical aperture device, and optionally the optical entrance, wherein the optical element may, optionally together with the optical entrance, be fixedly mounted to the housing while the optical aperture device may be moveable with respect to the housing. In this way, the relative distance between the optical element and optionally the optical entrance on the one hand, and the optical aperture device on the other hand may be varied by moving the optical aperture device with respect to the housing, or in other words inside the housing. According to a preferred embodiment, the housing may comprise a guide for guiding the movement of the optical aperture device with respect to the optical element, more preferably the guide being a recess in the housing configured as a tubular recess for cooperating with the tubular casing. In this way a translation, preferably a sliding movement, may be guided in an easy manner. Alternatively, an additional tubular assembly fixedly mounted to the housing may act as a guide. Preferably, the tubular casing may further comprise a groove at the first extremity of its outer surface for inserting said tubular casing withing the recess. The groove may allow in this way an easy insertion of the tubular casing within the tubular recess.

According to a preferred embodiment, the housing may comprise an interface for moving the optical aperture device, wherein the interface preferably may comprise an elongated opening allowing an external object to gain contact with the optical aperture device to displace said optical aperture device along the elongated opening. Alternatively, an interface for controlling a (linear) motor or a mechanical actuator may be envisaged to enforce a displacement of the optical aperture device based on a user input.

According to a preferred embodiment, the housing may comprise a fastening mechanism for fastening the optical aperture device to the housing, wherein preferably the fastening mechanism may comprise a threaded hole and a screw extending through the hole to gain contact with a recess on the outer surface of the optical aperture device. In this way, a user may easily fix the position of the optical aperture device after calibration of the spectrometer. Although, a screw has been disclosed, it is noted that alternative solutions using know fixing means (glue, clip, bolt) may be envisaged for fastening the optical aperture device to the housing without inventive step.

According to a preferred embodiment, the optical element may be a collimating optical element, more in particular a mirror, even more in particular a spherical mirror. According to a preferred embodiment, the opening of the exit aperture element may have a square shape. In this way, the shape of the opening of the exit aperture element may match the shape of the optical element. Alternatively, the opening of the exit aperture element may have a round shape. According to a preferred embodiment, the opening of the entrance aperture element may have a round shape. A round shape for the entrance aperture element avoids requiring aligning with the exit aperture element. Alternatively the entrance aperture element may have a square shaped opening to be aligned optionally with the optical element and/or the exit aperture element. Preferably, the entrance aperture element has an opening with the same shape as the opening of the exit aperture element. This option requires yet an accurate alignment of both openings.

According to a preferred embodiment, the spectrometer may further comprise a dispersive element, lensing optics and a detector.

According to another aspect of the invention, a calibration method for a spectrometer is provided, comprising in the following order the steps of:
a) measuring the spectral response of the spectrometer (100), preferably measuring the sensitivity, more preferably measuring the spectral sensitivity,
b) moving the optical aperture device (10) with respect to the optical element (20) to adjust the spectral response towards a reference spectral response.

In this way, the sensitivity may be controlled (without changing any element, like the slit, of the spectrometer) simply by adapting the position of the optical aperture device with respect to the optical device. This method allows increasing the unit to unit repeatability and versatility of use of the spectrometer and thus reducing costs.

The skilled person will understand that the reference spectral response may correspond to a desired curve at specific settings of the optical spectrometer (integration time, sensor sensitivity, etc.), with a given optical bench, and optionally including data processing (e.g. averaging) of data outputted by the optical spectrometer. The step of moving the optical aperture device is made in order to reproduce, or match, the reference spectral response using the same specific settings, optical bench, and optionally the same data processing. In practice, the reference spectral response may be obtained from a “mother” reference system with a working/proven sensitivity.

According to a preferred embodiment, the method further comprises iteratively performing a) and b) until the measured spectral response substantially resembles the reference spectral response. In this way, a calibration process may be performed especially for multiple devices, for which similar sensitivity settings may be easily set.

According to a preferred embodiment, the method further comprises, when the measured spectral response substantially resembles the reference spectral response, fastening the optical aperture device fixedly with respect to the optical element. In this way, the setting may be fixed for later use.

Although configured for spectrometers, the optical aperture device could be configured for other optical systems in general. The principle of the device described here is therefore not limited to spectrometers insofar as the concept of a moveable optical aperture device as disclosed here may also be applied accordingly for other types of optical devices.

This and other aspects of the present invention will now be described in more detail, with reference to the appended drawings showing currently preferred embodiments of the invention, wherein:

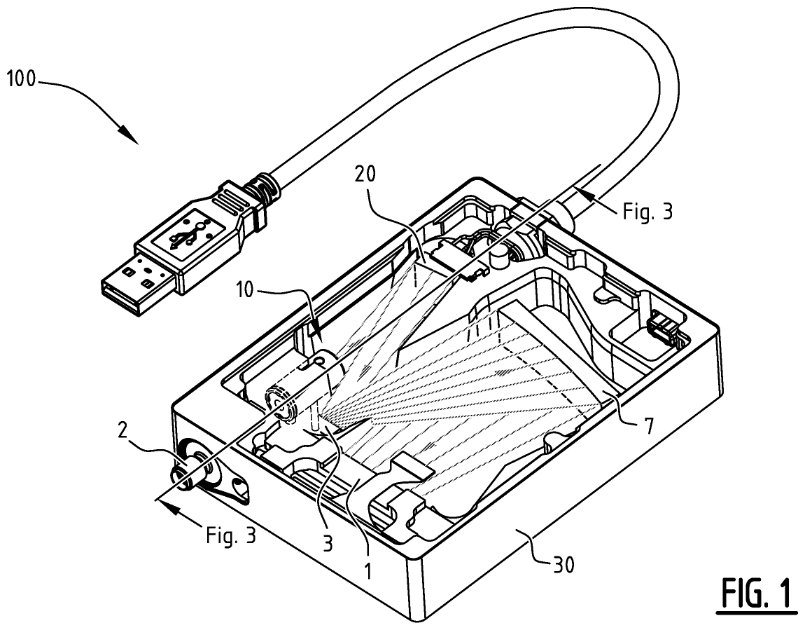

FIG. 1 illustrates a schematic perspective view of the inside of a spectrometer according to an embodiment of the invention;

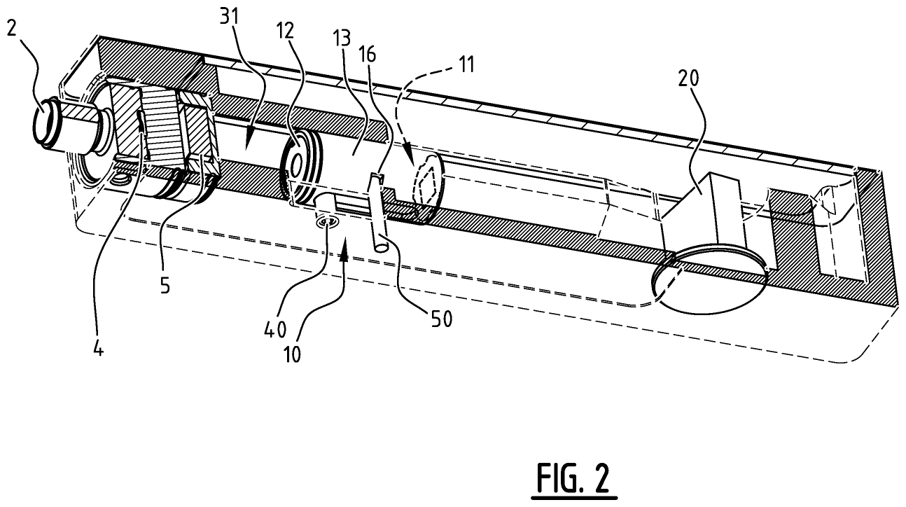

FIG. 2 illustrates a schematic see-through perspective section-view of a portion of the spectrometer according to FIG. 1, cut to show a perspective view of an optical aperture device according to an embodiment of the invention;

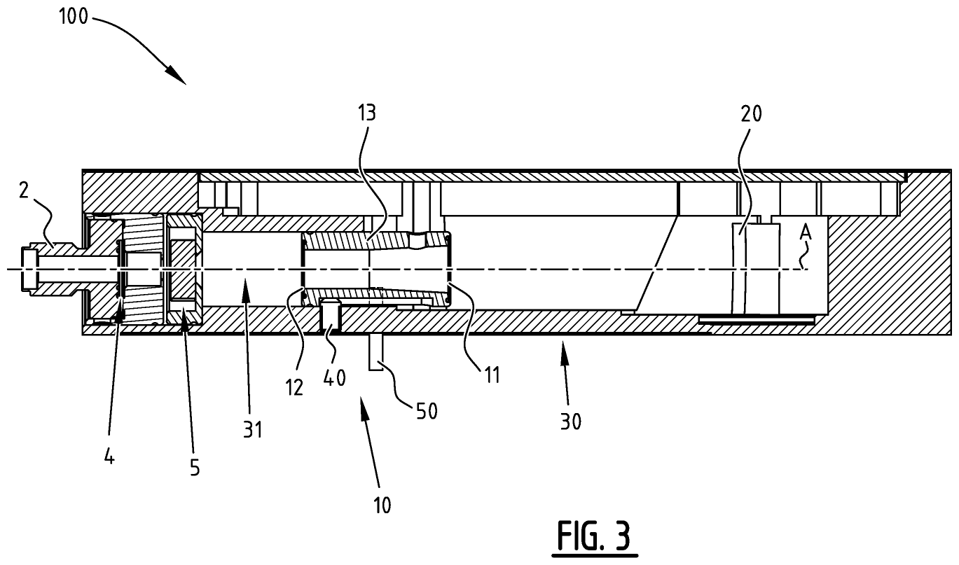

FIG. 3 illustrates a cross section of the spectrometer according to FIG. 1 along an optical axis A;

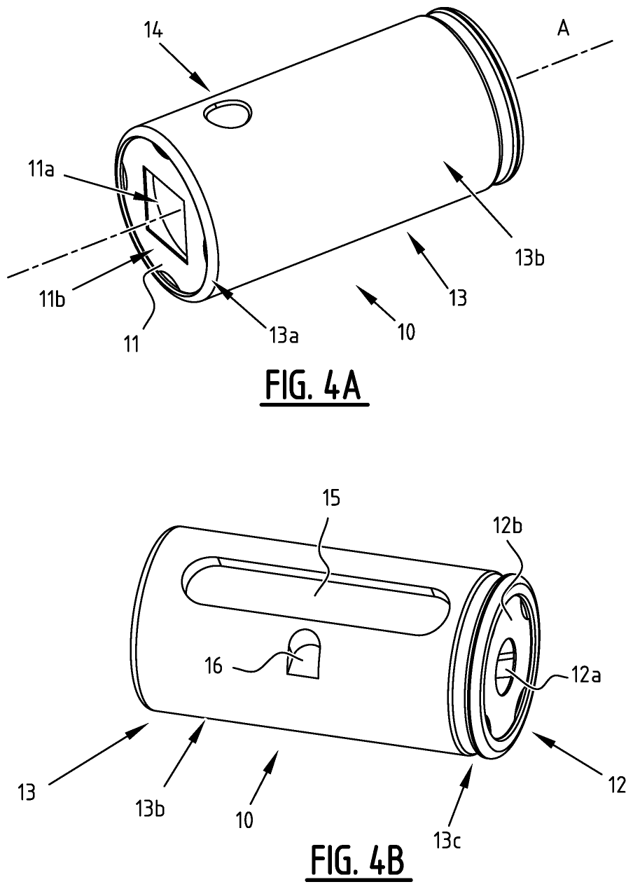

FIGS. 4A and 4B illustrate two perspective views of an optical aperture device according to an embodiment of the invention;

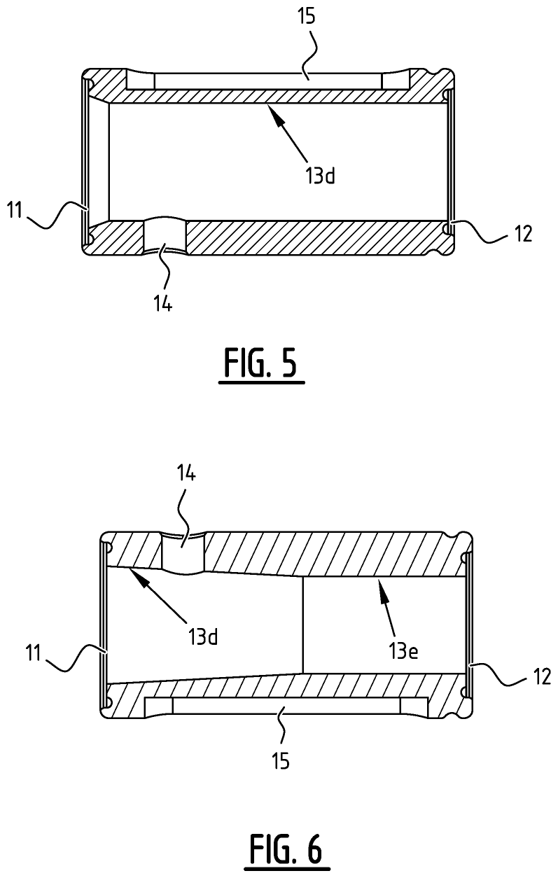

FIGS. 5-7 illustrate cross sections of optical aperture devices according to different embodiments of the invention;

FIGS. 8A and 8B show respectively a see-through perspective view of an optical aperture device according to yet another embodiment of the invention and a lateral cross section thereof;

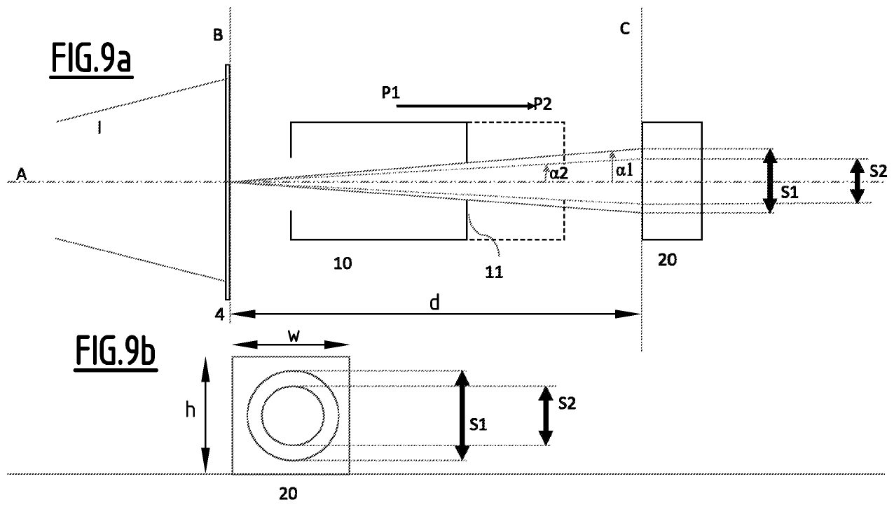

FIGS. 9a and 9b illustrate a schematic representation of a spectrometer of the invention for two different positions of the optical aperture device according to an embodiment;

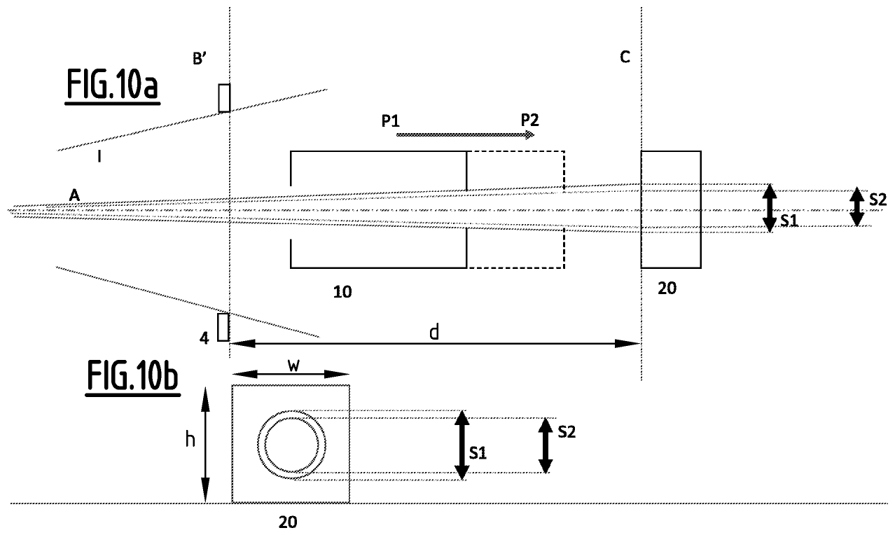

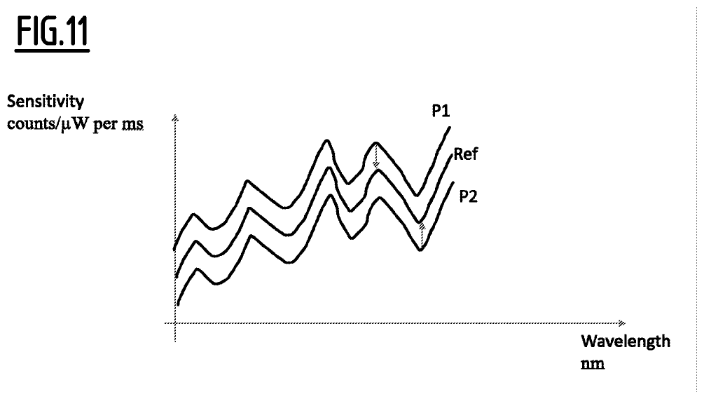

FIGS. 10a and 10b illustrate a schematic representation of a spectrometer of the invention for two different positions of the optical aperture device according to another embodiment;

FIG. 11 illustrates schematic sensitivity plots over the spectrum obtained for two different positions according to embodiments of any of the FIGS. 9a, 9b, 10a, 10b;

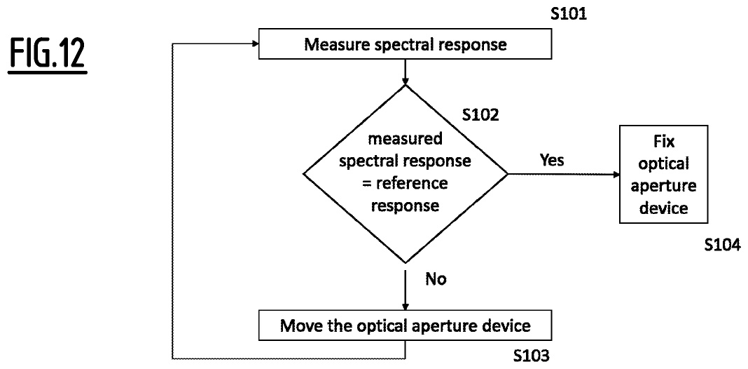

FIG. 12 illustrates a flowchart showing steps of a calibration method according to an embodiment of the invention.

It is noted that similar reference numbers are used throughout the figure description and Figures to describe similar elements. FIG. 1 illustrates a schematic perspective view of a spectrometer according to an embodiment. The spectrometer 100 may have a housing 30 with a lid (not represented) for closing the housing 30. Like in prior art systems, a connector 2 may protrude outside of the housing 30 of the spectrometer 100. The connector 2 may be configured to receive an optical fibre cable (not represented). An input optical signal (in other words an input light made of a bundle of light rays) may enter the optical spectrometer 100 through the connector 2 and progress through a slit 4 (shown more in detail in FIG. 2). The slit size may be typically in the order of tens to hundreds of microns and may influence both resolution and throughput into the optical spectrometer 100. The light coming out of the slit 4 may form a first optical signal and may then enter an optical aperture device 10. Although a slit 4 is shown, the function of that element is that of an optical entrance in the broad sense, and other alternatives for an optical entrance that may be envisaged (double-slit, etc) are within the scope of the invention. The optical entrance is configured for receiving the input optical signal, and for generating the first optical signal, said first optical signal being a diverging beam, preferably a conical diverging beam.

The optical aperture device 10 is configured for receiving the first optical signal and for selecting a portion thereof as a second optical light. In other words, the optical aperture device may control an amount of light at its exit, by cutting a portion of the incoming light out. The second optical signal may comprise only a portion of the light rays present in the first optical signal. The optical aperture device 10 may thus act as a physical filter, letting through only a portion of the light output from the slit 4. The second optical signal exiting the optical aperture device 10 may then impinge on the optical element 20 next in the optical path.

The optical element 20 is configured for receiving on its surface the second optical signal exiting the optical aperture device 10. Depending on embodiments, the optical element 20 may comprise any one of: a collimating element, a reflecting element (for example, a plane mirror), a grating element (for example, a concave grating). In the embodiment of FIG. 1, the optical element 20 may be acting as collimating optics and may typically be a spherical mirror. The second optical signal collimated by the optical element 20 may then reach a dispersive element 3 like a grating, and continue to lensing/focusing optics 7, for instance a spherical mirror, before finally impinging on a detector 1. The detector 1 may be one of a charged-coupled device (CCD) array or a complementary metal-oxide-semiconductor (CMOS) array. Several detectors suitable for that use are known in the art and may be selected based on the desired wavelength range, the measurement speed and the accuracy.

Contrary to the prior art, the optical aperture device 10 is moveable with respect to the optical element 20 to change the surface area of the light impinging on the optical element 20. In turn the size of that surface area may influence the illumination of the detector 1 (in the sense of amount of light) and thus the sensitivity of the spectrometer in terms of photon counts, for example normalized per μW per millisecond of integration time. The optical aperture 10 may be a moveable part of the spectrometer 100 while the connector 2, the slit 4, the mirrors 20 and 7, the grating 3 and the detector 1 may be mounted fixedly onto the housing 30 of the spectrometers. For calibration, the optical aperture device 10 may be moved with respect to the housing 30 of the spectrometer to adjust the spectral sensitivity of the spectrometer by varying the relative distance between the optical aperture device 10 and the optical element 20. Once the adjustment is performed, the optical aperture device 10 may be fixed to the housing 30, closing a calibration protocol of the spectrometer. A spectrometer may then be used for analysing samples. It is noted that the adjustment of the spectral sensitivity of a spectrometer may be of interest for calibration so that the data between different spectrometers may be comparable. Such a sensitivity adjustment may thus be performed as a calibration step among a batch of spectrometers intended to be used jointly. The range of movement of the optical aperture device may be such that the sensitivity may be adjusted within a margin of plus minus 5%, preferably plus minus 15%, more preferably plus minus 30%.

FIG. 2 illustrates a schematic see-through perspective view of a portion of the spectrometer 100 according to FIG. 1, with a section showing a perspective view of the optical aperture device 10 according to an embodiment of the invention. The connector 2 meant for connection to an external optical fibre (not represented) may house the slit 4 acting as an optical entrance. The distance between the slit 4 and the optical element 20 may be fixed, predetermined, to obtain a focused image on the surface of the optical element. Optionally a glass filter 5 may be inserted in between the slit 4 and the optical aperture device 10 along the optical path. The glass filter 5 may be used to filter second-order effects out. Alternatively, an order-sorting coating on a window in front of the detector may be provided. The filter 5 may limit the light to the region of the spectra, where order overlap is undesirable.

The optical aperture device 10 may comprise a tubular casing 13 holding an exit aperture element 11 and optionally holding an entry aperture element 12. The exit aperture element 11 may preferably be mounted at one extremity of the tubular casing 13, while the entrance aperture element 12 may preferably be mounted at the other extremity of the tubular casing 13.

Alternatively, the exit aperture element 11 may be mounted inside the tubular casing 13 at a predetermined distance from any one of its extremities, preferably in the last 50%, more preferably in the last 20%, even more preferably in the last 10%, of the tubular casing in its longitudinal direction with respect to an extremity thereof. It is noted that the tubular casing 13 may have a cylindrical outer shape, i.e. a circular outer cross section. Yet other outer cross sections may be envisaged by a person skilled in the art without inventive step, among which for example a rectangular outer shape cross section or a star outer shape cross section. The housing 30 comprise a recess 31 for receiving the optical aperture device 10. It is obvious that the recess 31 in the housing 30 may then have to be configured in conformity with the outer shape of the tubular casing 13. The recess 31 may also be acting as a guide for guiding the movement of the optical aperture device 10 with respect to the optical element 20. Alternatively, a separate tubular casing or assembly fixedly mounted to the housing may act as a guide.

As already explained for FIG. 1, the optical aperture device 10 is moveable with respect to the optical element 20. The size and position of the exit aperture element 11 with respect to the optical element 20 may determine the size of the surface area of the light impinging on the optical element 20, i.e. the illuminated area, and in turn the illumination of the detector 1. It is noted that the position of the slit 4 with respect to the optical element 20 is predetermined to obtain a focused image on the optical element 20. In that sense the size and position of the exit aperture element 11 with respect to the slit 4 influences as well the size of the surface area of the light impinging on the optical element 20, i.e. the illuminated area, and in turn the illumination of the detector 1. Indeed because the first optical signal propagates from the slit, only light rays of that first optical signal that are travelling in straight line from the slit to the aperture of the exit aperture element 11 may impinge on the optical element 20. The optical aperture device 10 may thus be regarded as moveable with respect to the set comprising the slit 4 and the optical element 20.

As previously discussed, the optical aperture device 10 may be inserted inside the housing 30 of the spectrometer 100 and may be typically mounted inside the housing 30. In particular, the tubular casing 13 may be moveably mounted within the tubular recess 31 in the housing 30 of the spectrometer 100. The tubular casing 13 may be thus guided by the tubular recess 31 to slide within the housing 30 along the optical axis A, being as well the longitudinal axis of the tubular casing 23 and the longitudinal axis of the tubular recess 31. In particular the outer dimensions (for example the diameter) of the tubular casing 13 may be smaller than the inner dimensions (for example the diameter) of the tubular recess 31 to allow a relative displacement between these elements 13 and 31.

To move the optical aperture device 20, an interface may be present on the outer surface of the housing 30 and on the outer surface of the optical aperture device 10. In an embodiment, a recess 16 may be present on the outer surface of the optical aperture device 10, more in particular on the outer surface of the tubular casing 13. A tool 50 (represented in FIG. 2 as a pin) may be inserted through a recess in the housing 30 to engage with the recess 16 to move the optical aperture device 10 in a direction parallel with the optical path. Alternatively, an interface comprising a motor or a mechanical actuator may be envisaged to enforce a displacement of the optical aperture device based on a user input.

FIG. 3 illustrates a cross section of the spectrometer according to FIG. 1 along the optical axis A, along which a direction of the optical path or main direction of propagation may be defined.

The optical axis A may be defined by the direct optical path through the optical aperture device 10 and optionally the slit 4 towards the optical element 20. The optical axis A may intersect the optical element 20 at the centre of its surface. The movement of the optical aperture device 10 may be a translation along the optical axis A. The range of movement may be such that the size of the illuminated area on the optical element 20 and hence the sensitivity may be adjusted within a margin of plus minus 5%, preferably plus minus 15%, more preferably plus minus 30%.

FIGS. 4a and 4b illustrate two perspective views of an optical aperture device according to an embodiment of the invention. In this embodiment, the tubular casing 13 may be a cylinder, holding at an extremity an entrance aperture element 12, and at the other extremity an exit aperture element 11. The exit aperture element 11 may comprise a surface 11b for blocking light from exiting the optical aperture device 10 and a rectangular opening 11a letting light exit the optical aperture device. The exit aperture element 11 may select only a portion of the first optical signal coming from the slit 4. The exit aperture element 11 may also trap stray light inside the tubular casing 13. The entrance aperture element 12 may comprise a surface 12b blocking light from entering the optical aperture device 10 and a circular opening 12a for letting light through to the inside of the optical aperture device. Other shapes of an opening 12a may be envisaged without inventive step. By adding an entrance aperture element, a first selection of light can be realised, while trapping stray light outside the tubular casing 13. Stray light may be defined as radiation of undesired wavelengths that if propagated may activate a signal at the detector 1. Sources of stray light in the detector 1 may include ambient light, scattered light from imperfect optical components or reflections of non-optical components, as well as order overlap. To reduce stray light propagation, a light absorbing coating may be applied to at least a portion of an inner surface 13d of the tubular casing 13. In this way, undesired reflections on said portion of the inner surface 13d may be reduced. The coating should have a low reflectance over the desired wavelength range. Preferably a straylight absorbing coating may be selected with an average reflectance over the whole wavelength range below at least 30%, more preferably below 15%, even more preferably above 10%. A black anodization coating may serve as a default solution.

On the outside surface 13b of the tubular casing 13, a fastening mechanism 40 for fastening the optical aperture device 10 to the housing 30 may be provided. The fastening mechanism 40 may comprise a hole extending from the outer surface of the housing 30 to the outer surface 13b, a screw and a recess 15 on the outer surface 13b of the tubular casing 13. The recess 15 may be an elongated recess to receive a fastening element according to a plurality of positions along the elongation of the recess. The screw may engage with the recess 15 to fixate the optical aperture device 10 in a fixed position after having used the tool 50 engaged in recess 16 to adjust its position. In this way, without opening the housing, an easy adjustment and fixation of the optical aperture device 10 may be realised. An interface for moving the optical aperture device may further provided.

On the outer surface 13b of the tubular casing, a groove 13c may be provided at the extremity of the tubular casing 13 away from the exit aperture element 11 (i.e. at the extremity of the tubular casing where the entrance aperture element 12 is hold) for an easy insertion of the optical aperture device 10 inside the recess 31 of the housing 30. Also, a hole 14 may be provided at the extremity of the tubular casing 13 where the exit aperture element 11 is hold, to grip the optical aperture device 10 and insert it into the recess 31.

FIGS. 5-7 illustrate cross sections of optical aperture device according to different embodiments of the invention.

FIG. 5 shows a cross section of an optical aperture device according to a first embodiment in which the inner surface 13d of the tubular casing 13 may have a cylindrical shape. This embodiment may be used as the reference to which other embodiments may be compared regarding the amount of straylight at the exit of the optical aperture device.

FIG. 6 shows a cross section of an optical aperture device according to a second embodiment in which a portion of the inner surface of the tubular casing 13 may be a conical portion 13d, and another portion of the inner surface of the tubular casing 13 may be a cylindrical portion 13e, the axis of the cone being the optical axis A. Compared to the reference embodiment of FIG. 5, the embodiment of FIG. 6 may show 4,5 times less stray light. The inner surface 13d may debouch at the extremity of the optical aperture device 10 at which the exit aperture element 11 is configured. In this way, stray light may reflect on the conical inner surface portion 13d away from the opening 11a of the exit aperture element 11 and thus may be trapped inside the optical aperture device 10. The conical portion may extend over at least 10% of the inner surface 13d, more preferably over at least 25%, even more preferably over at 40%, of the inner surface 13d. The conical portion 13d may have a section increasing along the optical path towards the exit aperture element 11.

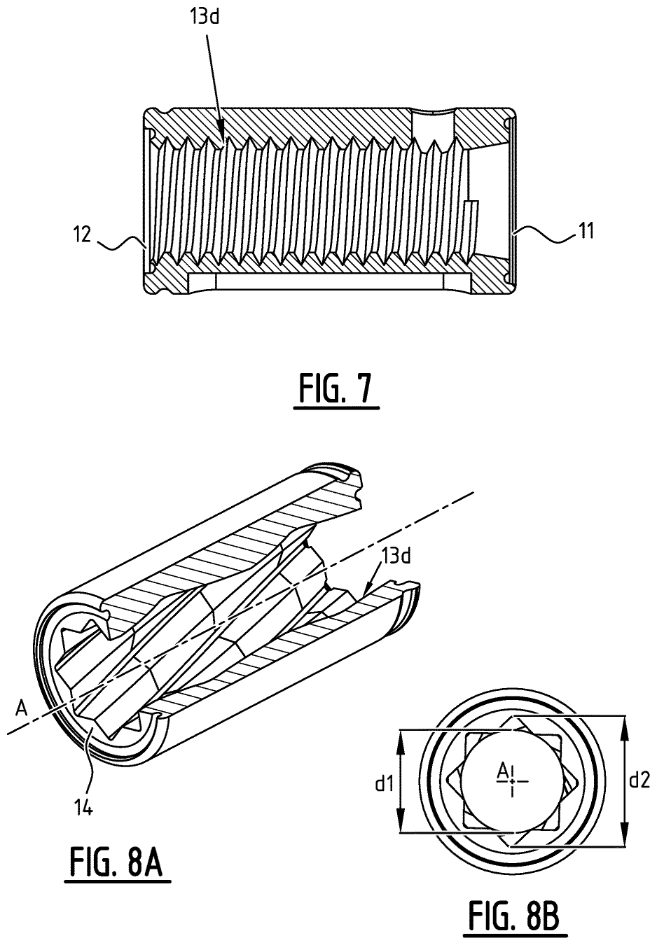

FIG. 7 shows a cross section of an optical aperture device according to a third embodiment in which the inner surface 13d of the tubular casing 13 may have a threaded portion. Compared to the reference embodiment of FIG. 5, the embodiment of FIG. 7 may show 5 times less stray light. In other words, the threaded inner surface may help further reducing stray light out of the optical path.

FIG. 8A shows a see-through perspective view of an optical aperture device according to yet another embodiment of the invention and a lateral cross section thereof. The inner surface 13d may then be spiral ribbed along the whole length of the tubular casing 13. Alternatively, only a portion of the inner surface of the tubular casing may be spiral ribbed. The spiral ribbed inner surface (portion) 13d may comprise ribs 14 extending in a spiralling/helicoidal pattern along the optical path. The ribs may have a substantially triangular cross section. The ribs 14 may extend towards the inside of the tubular casing and twist along the optical path. An helix angle may be defined between a rib and the optical axis A. The cross section of the spiral ribbed inner surface (portion) 13d is shown in FIG. 8B and may feature an eight-star shape with an inner diameter d1 corresponding to the top of the ribs 14 extending towards the optical axis A at the centre of the tubular casing 13, smaller than a diameter d2 corresponding to the valleys of the ribs 14. The multiple orientations of the surfaces on the spiral ribbed portion may reflect stray light in so many directions that stray light may be trapped inside the optical aperture device 10. The additional spreading of the angles of reflections directs the light rays away from the optical axis A. In this way, stray light may be further reduced. Compared to the reference embodiment of FIG. 5, the embodiment of FIG. 8 may show 15 times less stray light.

FIG. 9a illustrates a schematic sideview representation of a spectrometer of the invention for two different positions P1 and P2 of the optical aperture device 10. For the ease of explanation, in FIG. 9b, the optical element 20 may have a square shape and the exit aperture element 11 may have a round opening 11a. Yet the invention is not limited to such and other shapes of optical elements and exit aperture element openings may be envisaged.

An optical entrance 4, typically a slit, may receive the input optical signal I, typically from an optical fibre (not represented) with a given numerical aperture. The optical entrance 4 may then derive from the input optical signal I a first optical signal (not represented) downwards the optical path, i.e. along the optical axis A. Going through the optical entrance 4, light rays may be dispersed outwardly in the shape of a freeform light cone, preferably in the shape of a regular circular light cone as illustrated in the embodiment of FIGS. 9a and 9b. In other words, the light beam, i.e. the first optical signal, generated by the optical entrance 4 is a diverging light beam defined by a solid angle (also referred to as cone half-angle).

The plane perpendicular to the optical axis A at the optical entrance 4 may define an input plane B from which the first optical signal propagates. In other words, the optical entrance 4 may be seen from the elements further down along the optical path as a light source from which the first optical signal originates. It derives from it that the distance d between the optical element 20 and the input plane B may be predetermined to achieve the desired operation of the spectrometer, in particular to obtain an image on said optical element 20. Further, the optical element 20 may comprise a light receiving area thereof. The light receiving area may be defined by a height h and a width w. Based on the minimum between the width w and the height h of the light receiving area (i.e. a minimum lateral dimension of the light receiving area), and on the predetermined distance d, a maximum numerical aperture, NA, of the spectrometer may be derived.

In FIG. 9a, only some light rays exiting the optical aperture device 10 have been represented to explain the invention in a schematic way. When the optical aperture device 10 may be located at a position P1 along the optical axis A, the light exiting the optical aperture device 10 may be a portion of the first optical signal cut out of said first optical signal by the optical aperture device 10. The exit aperture element 11, and optionally the entrance aperture element 12 and/or the tubular casing 13 if present, may contribute to selecting said portion of the first optical signal. This portion of the first optical signal may be contained within a light cone originating from the input plane B and having a cone half-angle α1 (also referred to as first solid angle in the present text).

This light when impinging on the optical element 20 may form an illuminated area having a surface area with a diameter S1.

When the optical aperture device 10 may be located at a position P2 along the optical axis A, where the position P2 is closer to the optical element 20 than the position P1, the light exiting the optical aperture device 10 may be contained within a light cone originating as well from the input plane B and having a cone half-angle α2 (also referred to as second solid angle), smaller than the cone half-angle α1 (i.e. the first solid angle). This light when impinging on the optical element 20 may then form an illuminated area having a surface area with a diameter S2, smaller than the surface area of diameter S1 of the illuminated area obtained for the position P1. The solid angle of the second optical signal at the position P1 is thus larger than the solid angle of the second optical signal at the position P2.

FIG. 9b illustrates schematically the surface of the optical element 20 on which light impinges for the two positions illustrated in FIG. 9a. The surface of the optical element 20 may be in a plane C represented in FIG. 9a, said plane C being perpendicular to the optical axis A. The illuminated area may then be a disk with a diameter S1 when the optical aperture device 10 may be located at the position P1, and a smaller disk with a diameter S2 when the optical aperture device 10 may be located at the position P2. The shape of the opening 11a of the exit aperture element 11 may determine the shape of the illuminated area on the optical element 20. The distance between the exit aperture element 11 and the input plane B may determine the surface area of the illuminated area on the optical element 20. It is noted that the Figures are purely schematic and that dimensions may not be derived from them. The represented range of movement between P1 and P2, and extent of difference between the S1, S2 should not be considered as representative and serve merely the purpose of explaining the principle behind the invention.

As can be derived from these figures, by moving the optical aperture device 10 towards and away from the optical element 20, the surface of the light impinging on the optical element (said surface may also be referred to as illuminated area or image in the present invention) may be varied, such that the illumination and thus the sensitivity of the detector 1 may be adjusted. The dimensions of the illuminated area/image on the optical element 20 may typically vary from 10*10 mm to 7*7 mm for spectrometers in the range of 200 nm to 1100 nm when the optical aperture device 10 is displaced between its most extreme positions.

It is noted that the intensity received on the optical element 20 per unit of surface may remain the same when the optical aperture device 10 is moved. Moving the optical aperture device 10 may only modify the half-angle α of the cone of light reaching the surface of the optical element 20 (in other words without spreading the amount of light received). By moving the optical aperture 10, the amount of light received on the optical element 20 may be varied, and thus the sensitivity of the spectrometer may be tuned.

FIGS. 10a and 10b represent another embodiment of the invention, differing form the one shown in FIGS. 9a and 9b only in that a slit may be absent. The optical entrance 4 may directly be a fibre coupler located at plane B′ and receiving via a fibre (not represented) with a numerical aperture the input optical signal I. In that case, an input plane from which the light impinging on the optical element 20 would originate would be outside of the drawing, upwards the optical axis A. Yet the same principle as explained for FIGS. 9a and 9b would apply, namely by moving the optical aperture device 10, the size of the illuminated area on the optical element 20 may be varied, such that the sensitivity may be tuned.

Turning to FIGS. 11 and 12, the method of calibrating a spectrometer according to the invention is further explained. As explained the present invention is based on the idea of tuning the sensitivity separately from the resolution and in an homogenous manner over the spectrum. FIG. 11 schematically illustrates plots of the spectral response of a spectrometer according to the present invention for the two positions P1 and P2 of FIGS. 9a and 9b (or 10a, 10b, since P1 and P2 merely represent the most extreme moving positions of an optical aperture device according to any embodiment of the invention). The spectral response may be defined by measurements of the sensitivity in photon counts, for example normalized per microwatt per millisecond of integration time (counts/μW per ms), over the wavelength range of the spectrometer. As can be seen, the movement between P1 and P2 may translate the spectral response in terms of sensitivity. The movement of the optical aperture device 10 may thus result in an homogeneous adaptation of the spectral response.

In FIG. 11 is also represented a reference spectral response Ref which may be used as a calibration reference. The reference spectral response may be obtained using a standard input source. The skilled person will understand that the reference spectral response may correspond to a desired curve at specific settings of an optical spectrometer (integration time, sensor sensitivity, etc.), with a given optical bench, and optionally including data processing (e.g. averaging) of data outputted by the optical spectrometer. The step of moving the optical aperture device is made in order to reproduce, or match, the reference spectral response using the same specific settings, optical bench, and optionally the same data processing. In practice, the reference spectral response may be obtained from a “mother” reference system with a working/proven sensitivity.

To be able to compare the measured spectral responses of a spectrometer (that needs to be calibrated) to the reference one, the same standard source should be coupled to the spectrometer under calibration. A measured spectral response may for instance be plotted and presented to an operator on the same graph as the reference spectral response. In position P1, the spectral response may be above the desired reference spectral response, while in position P2, the spectral response may be below the desired reference spectral response. To reach the reference, so that the measured spectral response substantially resembles to the reference spectral response, the optical aperture device 10 may then be moved in one or the other direction depending on whether the measured response is above or below the reference. Arrows indicate in the figure the direction of the adjustment to meet the reference when starting either from P1 or P2. Moving from P1 to P2 amounts to displacing the optical aperture device in the direction of propagation of the optical signals, i.e. downwards the optical path, while moving from P2 to P1 amounts to displacing the optical aperture device 10 against the direction of propagation of the optical signals, i.e. upwards the optical path. The positions P1 and P2 may be selected to obtain a desired range of tuning around the reference.

FIG. 12 illustrates a flowchart showing steps of a calibration method according to an embodiment of the invention. At step S101, a spectral response of the spectrometer may be measured, preferably using the same standard source as the one used for obtaining the reference response. At step S102, the measured spectral response may be compared to the reference spectral response. In case of a difference, the optical aperture device may be moved at step S103. Steps S101, S102 and S103 may be iterated as long as the measured spectral response is different from the reference spectral response. Once a spectral response substantially resembling the desired reference spectral response is measured, the calibration may be ended. When performed by an operator moving the optical aperture 10 device in a stepless manner while measuring, the iteration may be done intuitively by the operator. Optionally, at S104, the optical aperture device may be fixed.

It is further noted that step S103 may comprise establishing a direction of movement depending on whether the spectral response is higher or lower than the reference spectral response. Whilst the principles of the invention have been set out above in connection with specific embodiments, it is understood that this description is merely made by way of example and not as a limitation of the scope of protection which is determined by the appended claims.

Further embodiments are described by the following clauses:

Clause 1. An optical spectrometer (100) for analysing an input optical signal, said input optical signal being inputted to the spectrometer, the optical spectrometer comprising:
an optical aperture device (10) configured for receiving a first optical signal derived from the input optical signal, and configured for selecting a portion of said first optical signal to generate a second optical signal exiting said optical aperture device, and
an optical element (20) configured for receiving on its surface the second optical signal exiting the optical aperture device,
characterised in that the optical aperture device (10) is moveable with respect to the optical element (20) to change a surface area of the second optical signal impinging on the optical element (20).

Clause 2. The optical spectrometer according to clause 1, further comprising an optical entrance (4) configured for receiving the input optical signal and for selecting a portion of the input optical signal to generate the first optical signal,
wherein preferably the optical entrance (4) comprises a slit element, more preferably said slit element defining an input plane (B) from which the first and the second optical signal originate and which distance to the optical element (20) is predetermined.

Clause 3. The optical spectrometer according to clause 1 or 2, wherein the optical aperture device (10) comprises an exit aperture element (11), said exit aperture element (12) comprising a surface (11b) for blocking a portion of an incoming optical signal and an opening (11a) for letting another portion of the incoming optical signal through.

Clause 4. The optical spectrometer according to any of the above clauses, wherein the optical aperture device (10) comprises an entrance aperture element (12), said entrance aperture element (12) comprising a surface (12b) for blocking a portion of an incoming optical signal and an opening (12a) for letting another portion of the incoming optical signal through.

Clause 5. The optical spectrometer according to clause 3 and/or 4, wherein the optical aperture device (10) comprises a tubular casing (13) for holding the entrance aperture element (12) and/or the exit aperture element (11).

Clause 6. The optical spectrometer according to the previous clause, wherein the tubular casing (13) defines a passage between a first extremity and a second extremity, said second extremity opposite the first extremity, wherein the tubular casing (13) is provided to the spectrometer such that the first extremity is upstream of the second extremity as seen in a direction of propagation of the optical signal.

Clause 7. The optical spectrometer according to the previous clause, wherein the exit aperture element (12) is provided to the second extremity of the tubular casing (13).

Clause 8. The optical spectrometer according to clauses 6 or 7, wherein the entrance aperture element (11) is provided to the first extremity of the tubular casing (13).

Clause 9. The spectrometer according to any of clauses 5-8, wherein the tubular casing (13) has an outer surface having a circular cross section.

Clause 10. The optical spectrometer according to any of clauses 7-9, wherein the tubular casing (13) has at least a portion of an inner surface (13d) configured for preventing light rays going through the exit aperture element after reflection on said at least one portion of the inner surface (13d).

Clause 11. The optical spectrometer according to any of clauses 5-10, wherein at least a portion of an inner surface (13d) of the tubular casing (13) is any one of the following and combinations thereof: a cylindrical portion, a conical portion, a threaded portion, a spiral ribbed portion.

Clause 12. The optical spectrometer according to any of clauses 5-11, wherein at least a portion of an inner surface (13d) of the tubular casing (13) has a light absorbing coating.

Clause 13. The optical spectrometer according to any of the above clauses, wherein the optical aperture device is configured to be moveable in a translation along an optical axis (A) of the optical aperture device (10).

Clause 14. The optical spectrometer according to any of the above clauses, wherein the tubular casing (13) can slide with respect to the optical element (20).

Clause 15. The optical spectrometer according to any of the above clauses, wherein the optical aperture device (10) is moveable between a first and a second position, wherein in the first position the surface area of the second optical signal impinging on the optical element (20) is set to a predetermined maximum size, and wherein said illuminate area is reduced by moving the optical aperture device from the first position to a second position by at least 10%, preferably by at least 30%.

Clause 16. The optical spectrometer according to any of the above clauses, wherein the optical aperture device is moveable between a first and a second position such that the sensitivity is adjusted by at least 10%, more preferably by at least 30%, even more preferably by at least 60% between the first and the second position.

Clause 17. The optical spectrometer according to any of the above clauses, and optionally according to clause 2, further comprising a housing (30) for holding the optical element (20) and the optical aperture device (10), and optionally the optical entrance (4), wherein the optical element (20) is, optionally together with the optical entrance (4), fixedly mounted to the housing (30) while the optical aperture device (10) is moveable with respect to the housing (30).

Clause 18. The optical spectrometer according to the previous clause, and optionally any of clauses 5-12, wherein the housing (30) comprising a guide for guiding the movement of the optical aperture device (10) with respect to the optical element (20), preferably the guide being a recess (31) in the housing (30) configured as a tubular recess for cooperating with the tubular casing (13), wherein more preferably the tubular casing (13) further comprises a groove (13c) at the first extremity of its outer surface for inserting said tubular casing (13) withing the recess (31).

Clause 19. The optical spectrometer according to any of the above clauses, wherein the housing (30) comprises an interface for moving the optical aperture device (10), wherein the interface preferably comprises a first elongated opening allowing an external object to gain contact with the optical aperture device and displace said optical aperture device along the elongated opening.

Clause 20. The optical spectrometer according to the previous clause, wherein the housing (30) comprises a fastening mechanism (40) for fastening the optical aperture device to the housing (30), wherein preferably the fastening mechanism comprises a hole and a screw extending through the hole to gain contact with the optical aperture device (10).

Clause 21. The optical spectrometer according to any of the above clauses, wherein the optical aperture device (10) comprises a recess (15) for receiving a fastening device configured to fasten the position of the optical aperture device (10) with respect to the optical element (20).

Clause 22. The optical spectrometer according to any of the above clauses, wherein the optical element (20) is a collimating optical element, more in particular a mirror, even more in particular a spherical mirror.

Clause 23. The optical spectrometer according to any of the above clauses, wherein the opening (11a) of the exit aperture element (11) has a square shape.

Clause 24. The optical spectrometer according to any of the above clauses, wherein the opening (12a) of the entrance aperture element (12) has a round shape.

Clause 25. The optical spectrometer according to any of the above clauses, further comprising a dispersive element (3), lensing optics (7) and a detector (1).

Clause 26. A calibration method for a spectrometer according to any of the above clauses, comprising in the following order the steps of:
a) measuring (S101) the spectral response of the spectrometer (100), preferably measuring the sensitivity, more preferably measuring the spectral sensitivity,
b) moving (S103) the optical aperture device (10) with respect to the optical element (20) to adjust the spectral response towards a reference spectral response.

Clause 27. The calibration method according to the previous clause, further comprising iteratively performing a) and b) until the reference spectral response is measured.

Clause 28. The calibration method according to the previous clause, when the reference spectral response is measured, fastening the optical aperture device (10) fixedly with respect to the optical element (20).

1. An optical spectrometer for analysing an input optical signal, said input optical signal being inputted to the spectrometer, the optical spectrometer comprising:
an optical entrance configured for receiving the input optical signal and for generating a first optical signal, said first optical signal being a diverging beam,
an optical aperture device configured for receiving the first optical signal derived from the input optical signal, and configured for selecting a portion of said first optical signal to generate a second optical signal exiting said optical aperture device, and
an optical element configured for receiving on its surface the second optical signal exiting the optical aperture device,
wherein the optical aperture device is moveable with respect to the optical element along a propagation direction of the first optical signal to change a surface area of the second optical signal impinging on the optical element

2. The optical spectrometer according to claim 1, wherein the optical entrance is further configured for selecting a portion of the input optical signal to generate the first optical signal or for coupling the input optical signal to the optical spectrometer to generate the first optical signal,
wherein preferably the optical entrance comprises a slit element or an optical coupler, more preferably said slit element defining an input plane from which the first and the second optical signal originate and which distance to the optical element is predetermined.

3. The optical spectrometer according to claim 1, wherein the optical aperture device comprises a first extremity and a second extremity opposite thereof, said first extremity being located upstream of the second extremity as seen along the propagation direction of the first optical signal;
wherein the optical aperture device comprises an exit aperture element preferably arranged closer to the second extremity than the first extremity, said exit aperture element comprising a surface for blocking a portion of an incoming optical signal and an opening for letting another portion of the incoming optical signal through; and/or wherein the optical aperture device comprises an entrance aperture element preferably arranged closer to the first extremity than the second extremity, said entrance aperture element comprising a surface for blocking a portion of an incoming optical signal and an opening for letting another portion of the incoming optical signal through.

4. The optical spectrometer according to claim 3, wherein the optical aperture device comprises a tubular casing for holding the entrance aperture element and/or the exit aperture element wherein preferably the tubular casing defines a passage between the first extremity and the second extremity, wherein the tubular casing is provided to the spectrometer such that the first extremity is upstream of the second extremity as seen in a direction of propagation of the optical signal.

5. (canceled)

6. The optical spectrometer according to any of claim 4, wherein at least one of: the exit aperture element is provided to the second extremity of the tubular casing the entrance aperture element is provided to the first extremity of the tubular casing.

7. (canceled)

8. The spectrometer according to claim 4, wherein the tubular casing has at least one of an outer surface having a circular cross section, at least a portion of an inner surface configured for preventing light rays going through the exit aperture element after reflection on said at least one portion of the inner surface.

9. (canceled)

10. The optical spectrometer according to claim 4, wherein at least a portion of an inner surface of the tubular casing is any one of the following and combinations thereof: a cylindrical portion, a conical portion, a threaded portion, a spiral ribbed portion.

11. The optical spectrometer according to claim 4, wherein at least a portion of an inner surface of the tubular casing has a light absorbing coating.

12. The optical spectrometer according to claim 1, wherein at least one of the optical aperture device is configured to be moveable in a translation along an optical axis (A) of the optical aperture device the tubular casing can slide with respect to the optical element.

13. (canceled)

14. The optical spectrometer according to claim 1, wherein the optical aperture device is moveable between a first and a second position, wherein at least one of, in the first position, a first illuminated area of the second optical signal impinging on the optical element is set to a predetermined maximum size corresponding to a maximum numerical aperture, NA, of the spectrometer, and wherein said first illuminated area is reduced by moving the optical aperture device from the first position to a second position by at least 10%, preferably by at least 30%, wherein preferably the first position corresponds to a position of the optical aperture device furthest from the optical element, and/or the second position corresponds to a position of the optical aperture device closest from the optical element.

15. The optical spectrometer according to claim 1, wherein the optical aperture device is moveable between a first and a second position such that at least one of:
the sensitivity is adjusted by at least 10%, more preferably by at least 30%, even more preferably by at least 60% between the first and the second position,
a resulting numerical aperture of an illuminated area of the second optical signal impinging on the optical element is adjustable from a maximum numerical aperture of the spectrometer, said maximum numerical aperture of the spectrometer being associated with the first position.

16. (canceled)

17. (canceled)

18. The optical spectrometer according to claim 1, further comprising a housing for holding the optical element and the optical aperture device and optionally the optical entrance wherein the optical element is, optionally together with the optical entrance fixedly mounted to the housing while the optical aperture device is moveable with respect to the housing wherein preferably the housing comprises a guide for guiding the movement of the optical aperture device with respect to the optical element, preferably the guide being a recess in the housing configured as a tubular recess for cooperating with the tubular casing, wherein more preferably the tubular casing further comprises a groove at the first extremity of its outer surface for inserting said tubular casing withing the recess.

19. (canceled)

20. The optical spectrometer according to claim 1, wherein the housing comprises an interface for moving the optical aperture device wherein the interface preferably comprises a first elongated opening allowing an external object to gain contact with the optical aperture device and displace said optical aperture device along the elongated opening, wherein preferably the housing comprises a fastening mechanism for fastening the optical aperture device to the housing, wherein more preferably the fastening mechanism comprises a hole and a screw extending through the hole to gain contact with the optical aperture device.

21. (canceled)

22. The optical spectrometer according to claim 1, wherein the optical aperture device comprises a recess for receiving a fastening device configured to fasten the position of the optical aperture device (10) with respect to the optical element

23. The optical spectrometer according to claim 1, wherein the optical element is a collimating optical element, more in particular a mirror, even more in particular a spherical mirror.

24. The optical spectrometer according to claim 3, wherein at least one of: the opening of the exit aperture element has a square shape, the opening of the entrance aperture element has a round shape.

25. (canceled)

26. The optical spectrometer according to claim 1, further comprising a dispersive element lensing optics and a detector

27. A calibration method for a spectrometer according to any claim 1, comprising in the following order the steps of:
a) measuring the spectral response of the spectrometer preferably measuring the sensitivity, more preferably measuring the spectral sensitivity,
b) moving the optical aperture device with respect to the optical element to adjust the spectral response towards a reference spectral response.

28. The calibration method according to the claim 27, further comprising iteratively performing a) and b) until the measured spectral response substantially resembles the reference spectral response, preferably further comprising the step of: when the measured spectral response substantially resembles the reference spectral response, fastening the optical aperture device fixedly with respect to the optical element.

29. (canceled)

30. An optical spectrometer for analysing an input optical signal, said input optical signal being inputted to the spectrometer, the optical spectrometer comprising:
an optical aperture device configured for receiving a first optical signal derived from the input optical signal, and configured for selecting a portion of said first optical signal to generate a second optical signal exiting said optical aperture device, and
an optical element configured for receiving on its surface the second optical signal exiting the optical aperture device,
wherein the optical aperture device is moveable with respect to the optical element to change a surface area of the second optical signal impinging on the optical element,
wherein the opening of the entrance aperture element has a round shape, and
wherein the opening of the exit aperture element has a square shape.
